(19) United States
(12) Patent Application Publication
(10) Pub. No.: US 2023/0229800 A1
(43) Pub. Date: Jul. 20, 2023

(54) CONTENT VARIATION TO TRACK DOCUMENTS

(71) Applicant: Citrix Systems, Inc., Fort Lauderdale, FL (US)

(72) Inventor: Ryan Matthew Casper, Conway, AR (US)

(21) Appl. No.: 17/647,992

(22) Filed: Jan. 14, 2022

(51) Int. Cl. G06F 21/62; G06F 40/197; G06F 40/40

(52) U.S. Cl. CPC G06F 21/6227; G06F 40/197; G06F 40/40

(57) ABSTRACT

In some embodiments, a method includes: generating, by the computing device, different variations of text based on a source document, the different variations to convey the same meaning as the source document while including content different than that of the source document; generating, by the computing device, copies of the document that include at least one of the different variations of the text, so that individual copies of the document are traceable based on the different variation of the text included within that copy of the document; and determining, by the computing device, a recipient of a copy of the document based on a different variation of the text included with the copy.

### BACKGROUND

Various types of organizations create documents and other forms of information that they intend to be kept confidential. As matter of convenience or practicality, an organization may publish or otherwise distribute such information in digital form. For example, a company may share business plans, product specifications, or other confidential information with its employees via email or by publishing the information on an internal server. As another example, a production company may distribute copies of a movie script to investors, directors, actors, etc. While organizations may attempt to limit the distribution and disclosure of information using confidentially agreements and secure distribution systems, the risk of unauthorized disclosures (or “leaks”) remains.

### SUMMARY

Embodiments of the structures and techniques disclosed herein can reduce the risk of the unauthorized disclosure of documents and other information by generating and distributing copies of a document that include subtly different variations (e.g., word usage, sentence punctuation, document formatting etc.) to different recipients, and by providing mechanisms for tracing particular copies of the document back to particular recipients or groups of recipients. Disclosed embodiments can be integrated within various systems, applications, and devices that provide for the creation, display, and/or distribution of documents. For example, some embodiments may be implemented as a plugin for MICROSOFT WORD such that a user can easily generate and distribute different copies of a document that is being created/edited within WORD. As another example, disclosed embodiments may be integrated into a document publishing and distribution system, such as content management systems (CMSs) and wikis. Thus, disclosed embodiments find practical application within various kinds of systems, applications, and devices and can provide technological improvements thereto (e.g., in terms improved security and reduced risk of unauthorized disclosure of documents).

According to one aspect of the disclosure, a method can include: generating, by a computing device, different variations of text based on a source document, the different variations to convey the same meaning as the source document while including content different than that of the source document; generating, by the computing device, copies of the document that include at least one of the different variations of the text, so that individual copies of the document are traceable based on the different variation of the text included within that copy of the document; and determining, by the computing device, a recipient of a copy of the document based on a different variation of the text included with the copy.

In some embodiments, the generating of the different variations of text includes generating the different variations of text using natural language processing (NLP). In some embodiments, the use of NLP includes sending a request to an NLP service, the request including at least a portion of the source document and an instruction for generating one or more variants of the source document. In some embodiments, the instruction for generating one or more variants of the source document includes an instruction for removing and adding punctuation from the at least a portion of the source document. In some embodiments, the request further includes one or more examples of variants of the source document.

In some embodiments, the method can further include: outputting, by the computing device, the copies of the document at one or more times; and storing information indicating the time at which individual copies of the document were output by the computing device, wherein the determining the recipient of a copy of the document includes determining a time at which the copy of the document was output by the computing device using the stored information. In some embodiments, the outputting of the copies of the document is in response to one or more requests for the source document. In some embodiments, the outputting of the copies of the document is in response to an input of a word processing application.

In some embodiments, the method can further include: sending, by the computing device, the copies of the document to one or more other computing devices; and storing information for determining which individual copies of the document were provided to which of the one or more other computing devices, wherein the determining the recipient of a copy of the document includes determining which of the one or more other computing devices the copy of the document was provided to using the stored information. In some embodiments, the determining the recipient of a copy of the document includes determining the recipient based on an using of a hash of the copy of the document. In some embodiments, the determining the recipient of a copy of the document includes determining the recipient using an excerpt of the copy of the document.

According to another aspect of the disclosure, an apparatus may include a processor and a non-volatile memory storing computer program code that when executed on the processor causes the processor to execute a process. The process may be the same as or similar to any of the method embodiments described above.

According to another aspect of the disclosure, a non-transitory machine-readable medium may encode instructions that when executed by one or more processors cause a process to be carried out. The process may be the same as or similar to any of the method embodiments described above.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 is a diagram of a system and environment for generating documents that can be tracked back to a recipient, according to some embodiments.

FIG. 5 is a diagram of a document storage system that can be provided with the system and environment of FIG. 4, according to some embodiments.

FIG. 5A is a diagram showing a portion of a database schema that can be used within the document storage system of FIG. 5, according to some embodiments.

FIG. 6 is a flow diagram showing an illustrative method for determining a recipient of a copy of a document, according to some embodiments.

The drawings are not necessarily to scale, or inclusive of all elements of a system, emphasis instead generally being placed upon illustrating the concepts, structures, and techniques sought to be protected herein.

### DETAILED DESCRIPTION

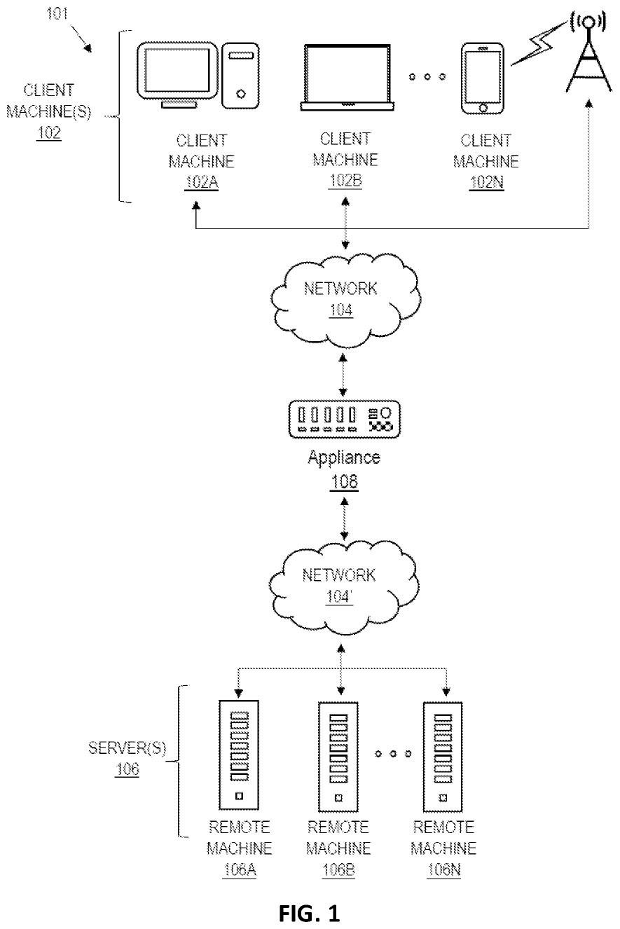

Referring now to FIG. 1, shown is an example network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

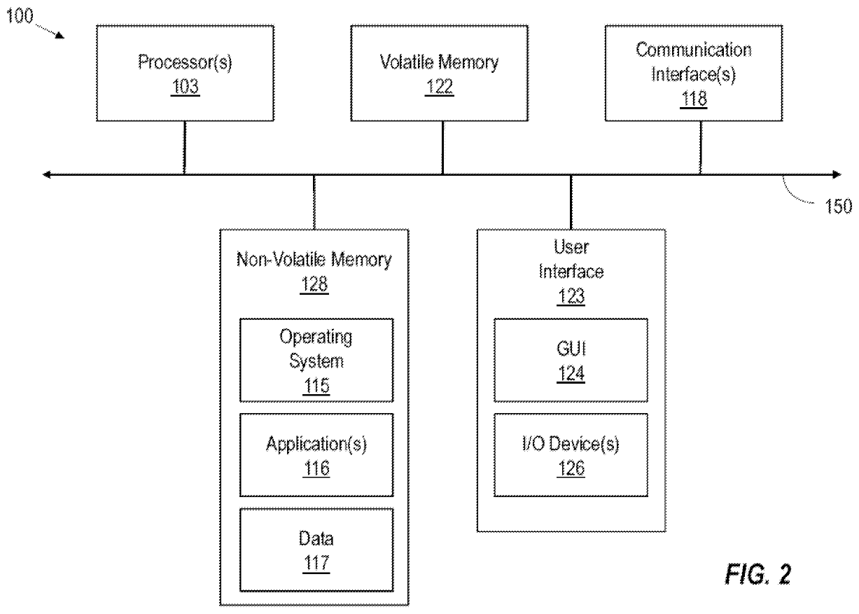

FIG. 2 is a block diagram illustrating selective components of an example computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an example client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed-signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

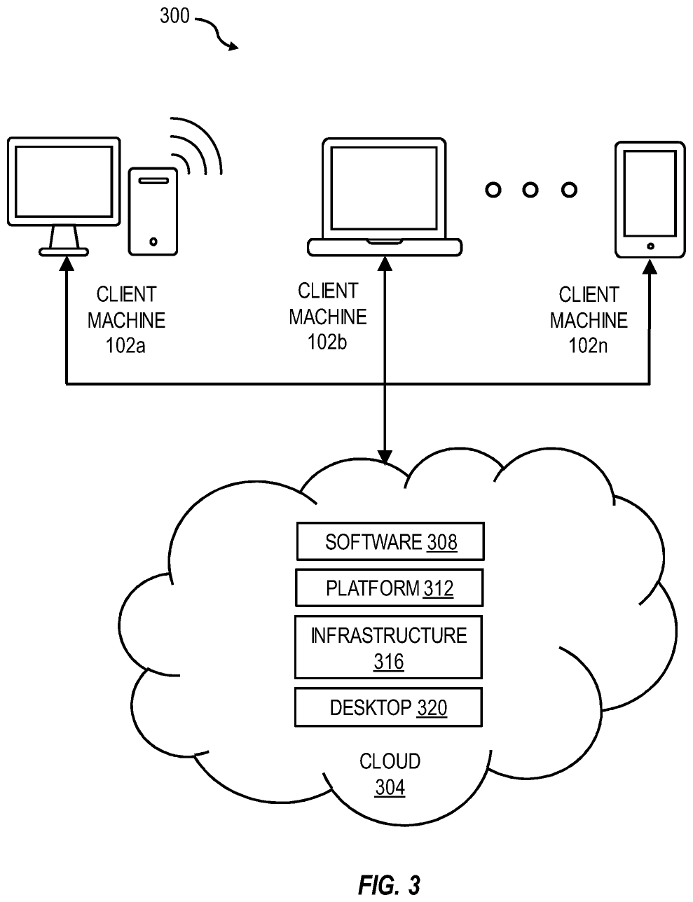

Referring to FIG. 3, a cloud computing environment 300 is depicted, which may also be referred to as a cloud environment, cloud computing or cloud network. The cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 300, one or more clients 102a-102n (such as those described above) are in communication with a cloud network 304. The cloud network 304 may include back-end platforms, e.g., servers, storage, server farms or data centers. The users or clients 102a-102n can correspond to a single organization/tenant or multiple organizations/tenants. More particularly, in one example implementation the cloud computing environment 300 may provide a private cloud serving a single organization (e.g., enterprise cloud). In another example, the cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 300 may provide a hybrid cloud that is a combination of a public cloud and a private cloud. Public clouds may include public servers that are maintained by third parties to the clients 102a-102n or the enterprise/tenant. The servers may be located off-site in remote geographical locations or otherwise.

The cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 300 can provide an elasticity to dynamically scale out or scale in response to different demands from one or more clients 102. In some embodiments, the cloud computing environment 300 can include or provide monitoring services to monitor, control and/or generate reports corresponding to the provided shared services and resources.

In some embodiments, the cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

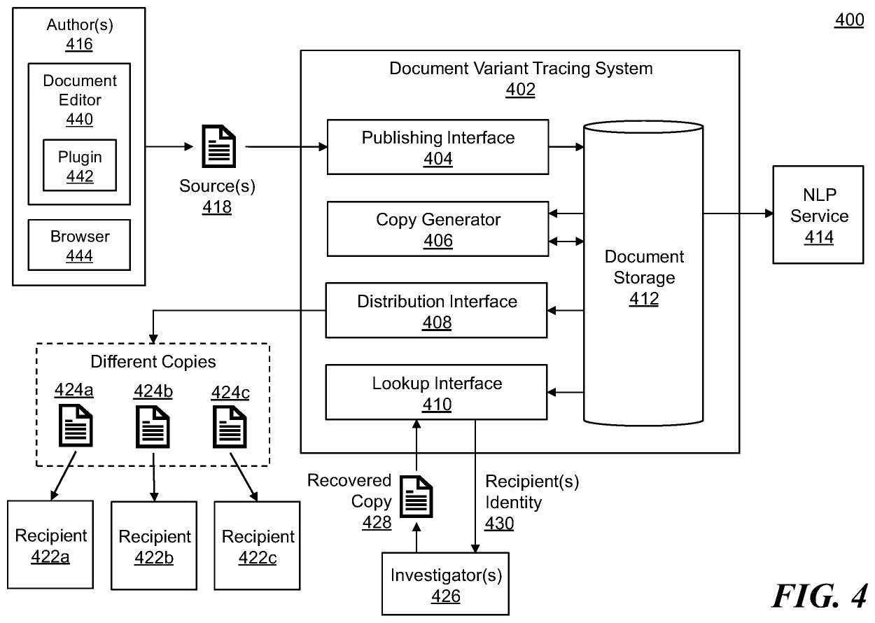

FIG. 4 shows an example of a system and environment to generate different copies of a document in which a recipient of a copy of the document can be identified based on the content of that copy (i.e., recipient tracking), according to some embodiments. An illustrative document variant tracing system (or “document tracing system” for brevity) 402 includes a publishing interface 404, a copy generator module 406, a distribution interface 408, a lookup interface 410, and a document storage system 412. The document tracing system 402 may be used within a computing environment 400 that further includes a natural language processing (NLP) service 414, one or more author clients 416, one or more recipient clients 422a, 422b, 422c, etc. (422 generally), and one or more investigator clients 426.

A particular client 416, 422, 426 may be same as or similar to a client machine 102 of FIG. 1 and/or FIG. 3. Document tracing system 402 can be provided within a server such as a server 106 of FIG. 1 and/or within a cloud network such as cloud network 304 of FIG. 3. In the case of a cloud network, interfaces 404, 408, 410 and module 406 may be deployed as cloud managed services and document storage system 412 may be provided as a cloud storage service. Clients 416, 422, 426 can communicate with document tracing system 402 via one or more computer networks, such as network 104 in FIG. 1. In some embodiments, investigator client 426 and author client 416 may correspond to the same computing device.

An author client 416 can prepare and send one or more documents (“source documents”) 418 to the document tracing system 402 for publication. In this disclosure, a document refers to any collection of text and possibly other types of content that can be displayed together on computing devices and transmitted electronically between computing devices. A document may have one of several different formats, such as a plain text format, Rich Text Format (RTF), Office Open XML or DOCX, Portable Document Format (PDF), HyperText Markup Language (HTML), LaTeX, etc.

Document tracing system 402 can be used to track copies of documents that include various kinds of textual syntaxes and semantics. For example, document tracing system 402 can be used to track documents that include words and sentences written in one more different human languages, such as English, French, and Chinese. As another example, document tracing system 402 may be used to track documents that include source code according to various computer programming languages, such as JAVA, PYTHON, C++, etc. A source document herein refers to a document in the form it was originally provided to document tracing system 402. In some cases, a user of author client 416 can create, generate, or otherwise prepare a source document 418 using a document editing application 440, such as a plain text editor, a word processing application such as WORD, or an application for creating Portable Document Format (PDF) files such as ACROBAT. In other cases, author client 416 may obtain the source document 418 from another source.

An author client 416 can submit a source document 418 to document tracing system 402 using publishing interface 404. In some embodiments, publishing interface 404 may provide an implementation of an application programming interface (API) that includes one or more API calls for submitting documents for publication, and author client 416 can include software configured to invoke such API calls. For example, a plugin 442 of document editing application 440 may be configured to invoke API calls of the publishing interface 404. In some embodiments, publishing interface 404 may provide an implementation of a user interface (UI) that includes controls for uploading/submitting source documents 418 to document tracing system 402. An author client 416 can include a web browser 444 or other type of client application for rendering the UI and for handling user inputs thereon.

In response to receiving a source document 418, publishing interface 404 can store the source document in the document storage system 412. The source document 418 may be assigned a value (“source document identifier”) that uniquely identifies the source document 418 within the document storage system 412 and that can subsequently be used to retrieve the source document from the document storage system 412. In some embodiments, the source document identifier may be a synthetic value generated by the document tracing system 402, such as a numeric identifier taken from a sequence. In some embodiments, the source document identifier may be generated based on the content of the source document 418. For example, a hash of the source document, or of textual content therein, may be used as the source document identifier. In some embodiments, the source document identifier may be generated based on a filename or other metadata of the source document 418. In this case, the publishing interface 404 may determine if the filename already exists within document storage system 412 and, if so, may generated an alternate filename that does not yet exist within document storage system 412 (e.g., by appending a sequence number).

Publishing interface 404 may return the source document identifier to author client 416 in one or more different forms. For example, publishing interface 404 may send author client 416 a Uniform Resource Locator (URL) or other type of link that includes the source document identifier and that can be used to access the source document 418 stored within the document tracing system 402 or to access different copies of the source document. In some embodiments, the link can include an address/path that is associated with distribution interface 408 such that when the link is used (e.g., clicked on within a browser), it causes a request to be sent to distribution interface 408 to distribute one or more different copies of the source document to one or more recipient clients 422, as discussed in more detail below.

In some embodiments, in response to receiving the source document 418, publishing interface 404 may additionally or alternatively instruct the copy generator module 406 to generate one or more different copies of the document. In some cases, also in response, publishing interface 404 may also instruct distribution interface 408 to distribute one or more of the different copies to one or more recipient clients 422. In this case, author client 416 may provide information (e.g., within an API call or as a submission of a form of a webpage) that can be used to distribute the copies to particular recipient clients 422. For example, author client 416 may provide email addresses associated with the recipient clients 422 and distribution interface 408 can send the different copies of the source document to those email addresses. Other methods of distribution that can be used are discussed below. In other embodiments, the disclosed functionality of copy generator module 406 may be invoked by distribution interface 408 in response to an API request or other type of request, as also discussed below.

Copy generator module 406 is configured to generate copies of source documents stored in document storage system 412 (e.g., documents received by publishing interface 404 and stored in document storage system 412). For a particular source document, copy generator module 406 can generate one or more copies that have different variations of text content found in the source document but that convey the same meaning as the source document. Thus, the copies may be described as “subtle” variations of the source document. As discussed further below, such copies can be tracked within the document storage system 412 and used to trace an individual copy back to a particular recipient or client device thereof (e.g., in the event of an unauthorized disclosure of that copy).

In some embodiments, copy generator module 406 can use NLP service 414 to generate different variations of the text of a source document. In some embodiments, NLP service 414 may correspond to a service that employs an autoregressive language model that uses deep learning to produce human-like text. Examples of such services include Generative Pre-trained Transformer 3 (GPT-3) and Generative Pre-trained Transformer 2 (GPT-2). NLP service 414 may provide an API with one or more calls for generating text based on a given prompt. As one example, the API may correspond to the OpenAI API. The prompt can include instructions and, in some cases, examples for generating the text. In the case where no examples are provided by the prompt, NLP service 414 may employ a “zero shot” approach to generating the text. If one or more examples are provided by the prompt, embodiments, NLP service 414 may use a “one shot” or “N shot” approach for generating the text.

In some embodiments, NLP service 414 may include multiple different models (or “engines”) with different capabilities and performance characteristics. The models may be grouped into sets, sometimes referred to as series or families of models. For example, GPT-3 provides a “Base” set of models that can understand and generate natural language, an “Instruct” set of models that are similar to the base series, but better at following instructions, a “Codex” set of models that can understand and generate code, including translating natural language to code, among others sets. The model to be used when generating text may be specified as a parameter of the API call NLP service. In some cases, the Base models may be used when one or more examples are available to be provided (i.e., using a one shot or N shot approach) as this can allow for optimizing specialized documents with unique formats. In some cases, the Instruct models may be used when no examples are available/provided (i.e., using a zero shot approach). The Instruct models may better suited for generating variants of certain “common” document formats like general text copy, scientific papers, specifications, etc. Instruct models may also be suitable for one shot approaches.

In some embodiments, copy generator module 406 can invoke an API call of NLP service 414 with a prompt that instructs NLP service 414 to reword the text of a source document in a manner such that the generated text conveys the same meaning as the source document. Various different approaches for constructing such a prompt may be used.

In some embodiments, copy generator module 406 can provide NLP service 414 with a prompt that has the following format: (1) instructions for generating subtlety different variations of text (e.g., instructions for removing and adding punctuation), (2) one or more examples of subtle variations generated based on an example source text, and (3) actual text from the source document for which copy generator module 406 is generating copies. For example, copy generator module 406 can provide NLP service 414 with the following prompt, delineated by triple quotes:

“““An English professor was trying to reword documents in a way that is subtly different that does not lose its meaning or grammar or style. Punctuation can be removed or added where it makes sense, too. It's almost impossible to detect from the casual eye what is different. See the examples below:

Original Version:

“SmartPhone 3Pro D42, SmartPhone 3Pro Max D43 and SmartPhone ABC123 will receive myOS 1.2.3 as standard throughout shipping release. Demo device holders are advised to be running myOS 1.2.3 and avoid formatting devices with an older build, 17A51b or 17A58c, respectively.”

Cleverly reworded versions (they are different in punctuation and spacing):

*SmartPhone 3Pro D42, SmartPhone 3Pro Max D43 and SmartPhone ABC123 have myOS 1.2.3 as standard throughout shipping release. Demo device holders are advised to be running myOS 1.2.3 and avoid formatting devices with an older build 17A51b or 17A58c, respectively.

*SmartPhone 3Pro D42, SmartPhone 3Pro Max D43, and SmartPhone ABC123 will receive myOS 1.2.3 as standard throughout shipping release. Demo device holders are advised to be running myOS 1.2.3 and avoid formatting devices with an older build 17A51b or 17A58c, respectively.

*SmartPhone 3Pro D42, SmartPhone 3Pro Max D43 and SmartPhone ABC123 are set to receive myOS 1.2.3 as standard throughout shipping release. Demo device holders are advised to be running myOS 1.2.3 and avoid formatting devices with an older build 17A51b or 17A58c, respectively.

*SmartPhone 3Pro D42, SmartPhone 3Pro Max D43 and SmartPhone ABC123 will be set to receive myOS 1.2.3 as standard throughout shipping release. Demo device holders are advised to be running myOS 1.2.3 and avoid formatting devices with an older build 17A51b or 17A58c, respectively.

*SmartPhones 11 Pro D42, 11 Pro Max D43 and 11 N104 will have myOS 1.2.3 as standard throughout shipping release. Demo device holders are advised to

*SmartPhone 3Pro D42, SmartPhone 3Pro Max D43 and SmartPhone ABC123 will have myOS 1.2.3 as standard throughout shipping release. Demo device holders are advised to

*SmartPhones 11 Pro D42, SmartPhone 3Pro Max D43 and SmartPhone ABC123 will be set to receive myOS 1.2.3 as standard throughout shipping release. Demo device holders are advised to

*SmartPhones 11 Pro D42, SmartPhone 3Pro Max D43 and SmartPhone ABC123 are set to receive myOS 1.2.3 as standard throughout shipping release. Demo device holders are advised to

*SmartPhone 3Pro D42, SmartPhone 3Pro Max D43, and SmartPhone ABC123 have myOS 1.2.3 as standard throughout shipping release. Demo device holders are advised to

Original Version:

“{input}”

Cleverly reworded versions (they are different in punctuation and spacing): *{output}”””

wherein the token {input} is replaced with text of the source document and *{output} corresponds to one or more variations of the source text to be returned by the API call of the NLP service 414. In this example, the text “An English professor was trying to reword documents in a way that is subtly different that does not lose its meaning or grammar or style. Punctuation can be removed or added where it makes sense, too. It's almost impossible to detect from the casual eye what is different. See the examples below:” within the corresponds to the instructions. In some embodiments, the number of variants to be generated may be specified as a parameter to the API call of the NLP service 414, where the default number is one. In some embodiments, copy generator module 406 may invoke the API call multiple times to obtain multiple different variants. In some embodiments, two or more API calls may be invoked sequentially, where the output of an earlier call is provided as input to a later call (e.g., to improve the quality of subsequently generated variants). It should be understood that the prompt above can be used when generating subtle variants regardless of the content of the source document. For example, although the illustrative prompt recites the term “SmartPhones” several times, it can be used when generating variants of documents that are entirely unrelated to “SmartPhones.”

As another example, the prompt may include the relatively shorter instructions of: “Reword the following text into a subtly different form that does not lose its meaning or grammar or style. Punctuation can be removed or added where it makes sense.” This type of prompt may be more suitable for use with the Instruct models when no examples are provided—or perhaps only one example is provided—and the source document has a “common” format. In some embodiments, one or more prompts may be stored as templates and made available to document tracing system 402. Different prompts may be selected for use based on the format of the source document (e.g., “common” formats versus “specialized” formats) and/or based on the number of examples available.

In some embodiments, copy generator module 406 can provide NLP service 414 with a prompt that has the following format: (1) instructions for generating subtlety different variations of text (e.g., instructions for removing and adding punctuation), and (2) actual text from the source document for which copy generator module 406 is generating copies. An example of such a “zero shot” prompt, delineated by triple quotes, is as follows:

“““Reword the following text into a subtly different form that does not lose its meaning or grammar or style. Punctuation can be removed or added where it makes sense.

Original Version:

“{input}”

Cleverly reworded versions (they are different in punctuation and spacing): *{output}”””

wherein the token {input} is replaced with text of the source document and *{output} corresponds to one or more variations of the source text to be returned by the API call of the NLP service 414.

In some embodiments, copy generator module 406 may instruct NLP service 414 to reword the text of a source document in a manner such that the generated text intentionally conveys different meaning as the source document. For example, in the case of a document that contains sensitive/valuable information, it may be advantageous to provide recipients with a copy that includes incorrect (but seemingly correct) information in attempts to uncover unauthorized disclosures without risk of exposing the sensitive/valuable.

In some embodiments, copy generator module 406 can specify, via an API call, which model the NLP service 414 should use when generating text based on given source text. For example, copy generator module 406 may analyze the source text to determine which model should be used based on the syntax and/or semantics of the text. In some embodiments, copy generator module 406 can analyze the text to distinguish between human-language text and computer programming-language text (or “code”) and can specify different engines to NLP service 414 based on this analysis. In some embodiments, NLP service 414 can be used to distinguish between human-language text and code. In some embodiments, the distinction between human-language text and code can be determined based on the context in which the variant is being generated (e.g., if the source document was received from a code repository or from a code review tool, then it can be assumed that the document includes code). In the case where NLP service 414 corresponds to GPT-3, copy generator module 406 may specify a model from the “Base” or “Instruct” sets of models in the case of human-language text, and may specify a model from the “Codex” set of models in the case of code. Copy generator module 406 may also adjust the NLP prompt depending on the syntax and/or semantics of the text. For example, in the case of code, copy generator module 406 may use a prompt that instructs NLP service 414 to change the order of operations in a manner that does not impact the results of the code when executed (e.g., the output and/or the side-effects of the code when compiled and executed by a computer processor).

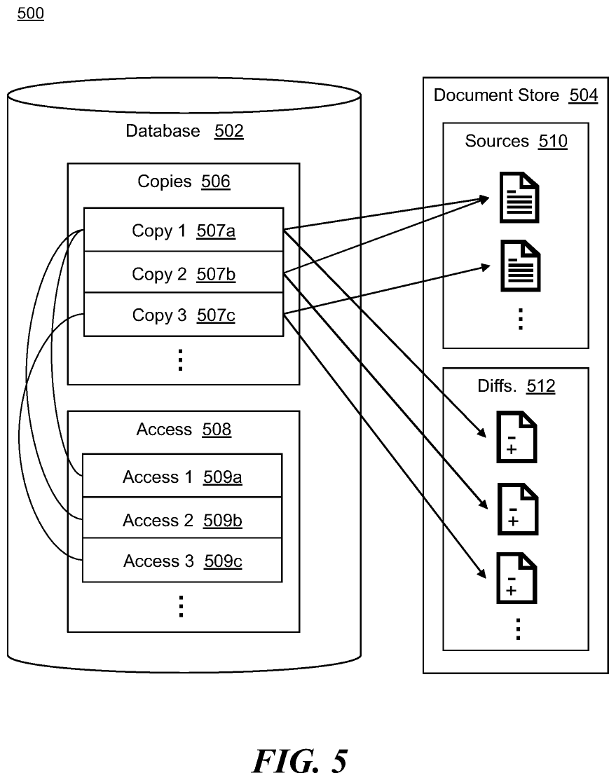

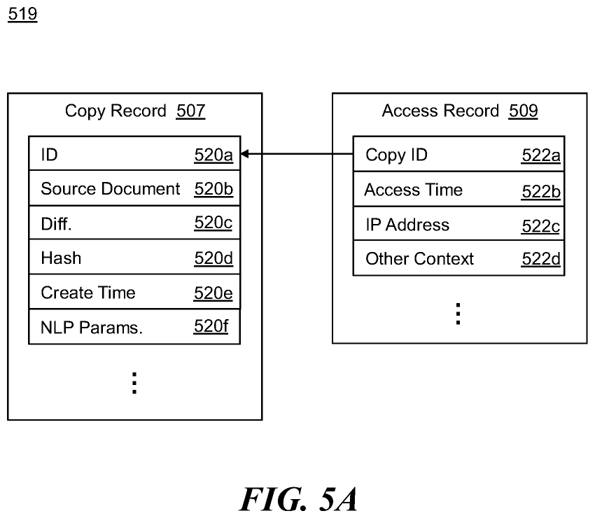

After receiving one or more variations of the text of a source document from NLP service 414, copy generator module 406 can generate one or more different copies of the source document based on those variations and store the copies, or information about the copies, within document storage system 412. In some embodiments, copy generator module 406 may compute a difference between the source document and a generated copy and store the difference within document storage system 412 along with a database record that points to both the stored source document and the stored copy. In some embodiments, copy generator module 406 may use a “diff” command to compute differences between a source document and a generated copy, or between the text of the source document and the text of the generated copy. Additional details of storing a generated copy within document storage system 412 are provided below in the context of FIGS. 5 and 5A.

In some embodiments, copy generator module 406 may be configured to extract text from various types of source documents prior to sending the text to NLP service 414. For example, copy generator module 406 may include libraries for extracting text from various documents formats such as Rich Text Format (RTF), Office Open XML or DOCX, Portable Document Format (PDF), HyperText Markup Language (HTML), LaTeX, etc. In some embodiments, copy generator module 406 can be configured to generate copies of the source document using the variations of the source text received from NLP service 414 in the same format as the corresponding source document. For example, if the source document is in DOCX format, a copy may also be generated in, or converted to, DOX format. In other embodiments, the generating of the copies in one or more different formats may be performed by distribution interface 408. For example, the copy generator module 406 may generate and store the different copies in a plain text format and distribution interface 408 may subsequently convert one or more copies from plain text to a different format (e.g., the same format as the source document) prior to distributing the copies to recipients clients 422.

In some embodiments, author client 416 may specify one or more parameters for generating copies when it sends the source document 418 to document tracing system 402 for publishing (e.g., as part of an API call to publishing interface 404). The parameters may be stored along with the source document 418 in the document storage system 412 or otherwise made available to copy generator module 406. For example, author client 416 can specify a section of the document (e.g., a range of page and/or line numbers) for auto-generating variations. This may be useful in the case where the source document 418 includes a section of sensitive/valuable information that is more likely be improperly disclosed than other sections. As another example, the parameters may specify which NLP model/engine to use. As another example, the parameters may specify whether the generated text should convey the same meaning or different meaning as compared to the source document.

In some embodiments, document tracing system 402 may include an interface that the author client 416 can use to approve or reject particular copies of a source document generated by module 406. This interface, which may be part of publishing interface 404 or a separate interface, may be used to help ensure that generated copies, or portions thereof, have the same meaning as the source document on which they are based (i.e., as a quality assurance mechanism).

Distribution interface 408 can be configured to distribute different copies of a source document to different recipient clients 422. A particular copy may be distributed to a single recipient client 522 or to multiple recipient clients 422. In the example of FIG. 4, a first copy 424a may be distributed to a first recipient client 422a, a second copy 424b may be distributed to a second recipient client 422b, and a third copy 424c may be distributed to a first recipient client 422c. The different copies 424a, 424b, 424c (424 generally) may include different variations of text based of the same source document while conveying the same meaning as the source document using the content generation techniques previously described. In this way, recipients of the different copies may be unaware that a copy of a document they are accessing via distribution interface 408 is different from the source document.

In some embodiments, distribution interface 408 may provide an implementation of an application programming interface (API) that includes one or more API calls for accessing the different copies 424, and recipient clients 422 and/or author clients 416 can include software configured to invoke such API calls. For example, a plugin 442 of document editing application 440 may be configured to invoke API calls provided by distribution interface 408 for downloading the copies 424 for indirect distribution to recipient clients 422. In some embodiments, distribution interface 408 may provide an implementation of a user interface (UI) that includes controls for accessing (e.g., viewing or download) a copy of a source document. A recipient client 422 can include a web browser (not shown) or other type of client application for rendering the UI and for handling user inputs thereon.

Distribution interface 408 can provide one or more methods of distributing the different copies 424 generated by document tracing system 402, and the particular method of distribution used may be specified by a recipient client 422 or, in some cases, by an author client 416. For example, distribution interface 408 may transmit a copy 424 to a recipient client 422 in a response to an API call initiated by recipient client 422. As another example, distribution interface 408 may render a copy 424 within a web page displayed by a recipient client 422. As another example, distribution interface 408 may email a copy 424 to a recipient client 422 (or, more particularly, to an email address associated with the recipient client 422) in response to an API call initiated by an author client 416. In some embodiments, different copies 424 may be distributed to recipient clients 422 indirectly. For example, an author client 416 may download one or more different copies via distribution interface 408 and then send the copies to recipient clients 422 using email, a file sharing service, etc.

A recipient client 422 (or author client 416) may specify a source document identifier in an API call or a browser request sent to distribution interface 408. Using the source document identifier, distribution interface 408 can locate a copy of the source document that was previously generated and stored within document storage system 412 (e.g., by copy generator module 406). Document storage system 412 can also track which copies of a source document have been accessed, i.e., previously distributed or “used.” In some cases, in response to an API call/browser request for a document, distribution interface 408 may locate a copy of the document that has not been previously used and then update document storage system 412 to indicated that the copy has been accessed/used. In addition to indicating that the copy has been accessed, document storage system 412 may also record various contextual information about the access such as the time of the access and information about the client that initiated the access, such as its IP (internet protocol) address. More generally, document storage system 412 can store a mapping between different copies 424 of a source document and the recipient devices 422 that accessed those copies (or, in some cases, the author client 416). Techniques and structures for tracking access to different copies of a document are described below in the context of FIGS. 5 and 5A. Distribution interface 408 can then provide the recipient client 422 with access to the located copy using any of the previously discussed distribution methods. In some embodiments, if distribution interface 408 cannot locate a copy of the source document (e.g., an unused copy), it may invoke copy generator module 406 to generate one or more copies and then distribute one of the newly generated copies to the recipient client 422. Thus, in some embodiments, different copies of a source document may be generated “on-the-fly.”

In some embodiments, copy generator module 406 may generate (e.g., automatically generate) a certain number of different copies of a source document in response to a source document 418 being stored within document storage system 412. The number of copies may be specified within an API call initiated by an author client 416, or it may be a configuration parameter of the document tracing system 420 (e.g., a parameter that is configurable on a per-user or per-organization basis). In some embodiments, copy generator module 406 may maintain at least a threshold number of unused copies of a source document 418 within the document storage system 412. For example, copy generator module 406 may periodically query document storage system 412 for the number of unused copies available for a particular source document and, if that number is less than the threshold, it may automatically generate and store additional copies. The new, unused copies are then available for distribution via distribution interface 408.

Lookup interface 410 can provide an API or UI for determining a recipient of a copy of a document that was generated and distributed by document tracing system 402 based on the contents of the copy. Referring to the example of FIG. 4, assume that an unknown one of the different recipient clients 422a, 422b, 422c, or a user thereof, discloses its respective copy 424a, 424b, 424c of the source document in an unauthorized manner. Further assume that the unauthorized disclosure is detected and that the copy, show as copy 428 in FIG. 4, is recovered. To determine which of the recipient clients 422 is responsible for the unauthorized disclosure of the recovered copy 428, the investigator client 426 can submit the recovered copy 428 to lookup interface 410 by initiating an API call or uploading it via a UI. In some embodiments, the investigator client 426 may also submit information about the source document from which the copy was generated, such as the source document identifier or the source document itself.

In response to receiving the recovered copy 428, lookup interface 410 can compare some/all of the text of recovered copy 428, or a hash thereof, to information about generated copies that is stored within the document storage system 412. Based on this comparison, lookup interface 410 can determine which one of the different copies 424 that were distributed by document tracing system 402 corresponds to the recovered copy 428. For example, lookup interface 410 may determine that the recovered copy 428 corresponds to first copy 424a. Then, lookup interface 410 can determine which recipient, or group of recipients, had access to the recovered copy 428 using a stored mapping accesses-to-copies stored within document storage system 412. Lookup interface 410 can return information 430 identifying the recipient(s) back to investigator client 426, as shown. For example, the returned information 430 may indicate that recipient device 422a had access to the first copy 424a, which corresponds to the recovered copy 428.

Lookup interface 410 can use one or more techniques to determine which of multiple different copies 424 distributed by document tracing system 420 corresponds to a recovered copy 428 submitted by an investigator client 426. For example, lookup interface 410 may compute a hash of the recovered copy 428, or of its text content, and then compare the hash to hashes stored in document storage system 412 for the different copies 424.

As another example, lookup interface 410 may compute a difference between the recovered copy 428 and the corresponding source document, or between the text of these two documents, and then compare the difference to differences previously computed and stored in document storage system 412 for the different copies 424. Here, lookup interface 410 may obtain the source document directly from the investigator client 426 (e.g., via an API call initiated by investigator client 426) or it can retrieve the source document from document storage system 412 using a source document provided by investigator client 426.

As another example, lookup interface 410 may compare only portions of the recovered copy 428 to information stored in document storage system 412 to determine which of the different copies 424 corresponds to the recovered copy 428. For example, lookup interface 410 may excerpt a portion of text from a particular location within the recovered copy 428 and compare the excerpted text, or a difference between the excerpted text and the source document, to determine the corresponding one of the difference copies 424. With this approach, it may be possible to determine which of the difference copies 424 corresponds to the recovered copy 428 even if modifications were made to the recovered copy 428 after it was distributed by the document tracing system 402.

In some embodiments, two or more of the above techniques can be used to increase the accuracy the information 430 returned by lookup interface 410.

As previously discussed, in some cases, author client 416 may receive one or more different copies of a source document from document tracing system 402 and distribute those copies to one or more recipients such that the recipients are given indirect access to the copies. Here, document storage system 412 may record contextual information about the access by author client 416 rather than access by recipient devices 422. Thus, in some embodiments, the information 430 returned by lookup interface 410 to investigator client 426 may include information that can be used to indirectly determine the identity of a recipient that distributed/disclosed the copy in an unauthorized manner. For example, the returned information 430 can include a timestamp corresponding to the time the copy was accessed by the author device 416.

FIG. 5 shows an example of a document storage system 500 that can be provided within a document tracing system, such as document tracing system 402 of FIG. 4, according to some embodiments. The illustrative document storage system 500 includes a database 502 and a document store 504. Database 502 may correspond to, for example, a relational database, an object-oriented database, a key-value store, etc. Document store 504 may correspond to, for example, a filesystem or any other device capable of storing documents. In some embodiments, database 502 may be provided as a database capable of storing documents (e.g., as “blobs”) and, thus, the separate document store 504 may be omitted.

The illustrative database 502 can include a copies table 506 and an access table 508. Copies table 506 can be configured to store information about different copies of source documents generated by the document tracing system. For example, copies table 506 can store copy records 507a, 507b, 507c (507 generally) corresponding to different copies of a source document generated by the document tracing system. Access table 508 can be configured to store information about which of the copies have been accessed along with contextual information about individual accesses. For example, access table 508 can store access records 509a, 509b, 509c (509 generally) corresponding to individual accesses of various generated copies. FIG. 5A shows details examples of a copy record 507 and of an access record 509.

The copies table 506 and the access table 508 may include a relationship (e.g., a foreign key relationship) such that particular copy records 507 can be linked/mapped to particular access records 509. This relationship can be used by the document tracing system to track different copies of a source document back to particular recipients. In the example of FIG. 5, a first copy record 507a is shown (using curved lines) as being linked to both a first access record 509a and a second access record 509b, a second copy record 507b is shown as not being linked to any access records, and a third copy record 507c is shown as being linked to a third access record 509c. Thus, in this example, a first copy corresponding to first copy record 507a was accessed twice, a second copy corresponding to second copy record 507b has not been accessed (i.e., it is “unused”), and a third copy corresponding to third copy record 507c was accessed once.

Document store 504 can store source documents 510 published to the document tracing system along with differences 512 computed between source documents and a generated copy. A copy record 507 may include a pointer to a particular source document and to a particular computed difference 512, as shown using arrows in FIG. 5. That is, when the document tracing system generates a copy of a source document using any of the techniques described above, it may (1) store the source document in document store 504 (if it was not already stored), (2) compute a difference between the generated copy and the source document, (3) store the computed difference in document store 504, and (4) generate and store a new copy record 507 that includes pointers to the source document and to the computed difference within document store 504. Such pointers may correspond to file system paths, filenames, synthetic identifiers, or other identifiers that uniquely identify the source document and the difference within document store 504. For example, a source document identifier as described above may be used as a pointer to a source document stored within document store 504.

FIG. 5A shows a portion of a database schema 519 that can be used within the document storage system of FIG. 5, according to some embodiments. As shown, a copy record 507 can include, among other fields: a unique identifier 520a (e.g., a synthetic primary key), a pointer to a source document 520b, a pointer 520c to a difference computed between a generated copy and the source document or between the texts thereof, a hash 520d of the generated copy or of the text thereof, a timestamp 520e representing the time the copy was generated, and the NLP parameters 520f used to generate the copy (e.g., the prompt provided to the NLP service, the NLP model/engine used, etc.).

As also shown, an access record 509 can include, among other fields: an identifier 522a (e.g., a foreign key) that refers to a particular copy record 507, a timestamp 522b representing the time that copy was accessed, an IP address 522c of the compute device that accessed the copy (e.g., an IP address of a recipient client), and other contextual information 522d about the access. Non-limiting examples of other contextual information 522d include duration of view/visit, browser-agent information, cookie identifiers, the referral information for the link that was clicked, login name for the viewer, and any other identifying information that may be useful for tracing a variant back to a recipient.

In practice, a copy record 507 can include various other fields for tracking and debugging copies of a source document generated by the document tracing system. Likewise, an access record 509 can include various other fields for tracing a particular copy back to a computing device, or multiple computing devices, that were given access to the copy.

The illustrative document storage system 500 of FIG. 5 and corresponding schema 519 of FIG. 5A can allow for tracing a particular copy of a source document (e.g., a copy that was disclosed without authorization) back to one or more recipient devices, or users thereof, that were given access to the copy, as discussed below.

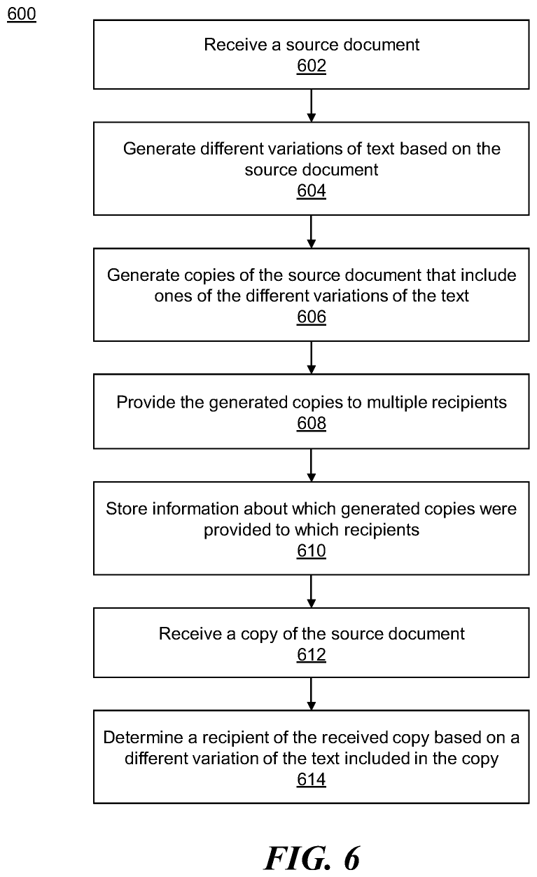

FIG. 6 shows an illustrative method 600 for determining a recipient of a copy of a document, according to some embodiments. The method 600 can be implemented, for example, within document tracing system 402 of FIG. 4.

At block 602, a source document is received. For example, the source document may be received from a client device, such as author client 416 of FIG. 4. In some cases, the source document may be received from a plugin of a document editing application, such as a WORD plugin. In some embodiments, the source document may be received via an API call. In some embodiments, the document may be stored in a document storage system.

At block 604, different variations of text based on a source document may be generated. The different variations may convey the same meaning as the source document while including content different than that of the source document. In some embodiments, an NLP service, such as NLP service 414 of FIG. 4, may be used to generate the different variations of text. Various techniques for instructing an NLP service to generate such variations are described in detail above in the context of FIG. 4.

At block 606, copies of the source document that include ones of the different variations of the text may be generated. The copies and/or or information about the copies may be stored in the document storage system. For example, referring to FIG. 5, a copy record 507 may be generated and stored in the copies table 506 of database 502. The copy record may point to the stored source document. In some embodiments, a difference between the copy and the source document may be computed and stored in the document storage system, and a pointer to the stored difference may be included within the copy record. In some embodiments, the copies may be generated to have the same format (e.g., plain text, DOCX, PDF, etc.) as the corresponding source document.

At block 608, different copies of the source document may be provided to (e.g., distributed to or access by) different recipients, such as to recipient devices 422 of FIG. 4. Various methods for distributing generated copies of a document to recipients are described above in the context of FIG. 4.

At block 610, information about which generated copies were provided to which recipients may be stored. For example, referring to FIG. 5, an access record 508 that links to the corresponding copy record 507 may be generated and stored in the document storage system 500.

At block 612, a particular copy of the source document may be received. For example, a copy that was disclosed without authorization may be recovered. In some embodiments, the recovered copy may be received via an API call. For example, referring to FIG. 4, an investigator device 426 may submit the recovered copy 428 to lookup interface 410 using an API provided thereby.

At block 614, a recipient of the received copy may be determined based on a document based on a different variation of the text included with the copy. Some or all of the text of the received copy, or a hash thereof, may be compared to the information about the generated copies stored in a document storage system (e.g., at block 606). For example, referring to FIG. 5, a hash of the received copy may be used to identify a corresponding copy record 507. Then, one or more access records 509 linked to the copy record 507 can be identified. Information within the access record(s) 509 can be used to determine one or more recipients of the received copy. For example, an access record 509 may indicate an IP address of a client that accessed the received copy.

Disclosed embodiments may be integrated within or deployed in conjunction with various applications and systems that involve the use of documents including word processors and other document editing applications (e.g., MICROSOFT WORD), document publishing and distribution systems (e.g., content management systems like CONFLUENCE wiki), various types of websites and SaaS applications, virtual applications, etc. Disclosed embodiments can enhance applications and systems such that they either (a) on-the-fly or (b) at time of publishing, subtly vary a document they are publishing or displaying and record information that can be used to trace particular variations or copies back to particular recipients/viewers. Disclosed embodiments provide a subtle and hard-to-detect (and ideally undetectable) watermarked document that, upon recovery by an investigator (or if published in the media or other unauthorized source), can be traced back to the leaking recipient due to its subtle variation. This can improve the security of the document systems and reduce the risk of unauthorized disclosures.

The following examples pertain to further embodiments, from which numerous permutations and configurations will be apparent.

Example 1 includes a method including: generating, by a computing device, different variations of text based on a source document, the different variations to convey the same meaning as the source document while including content different than that of the source document; generating, by the computing device, copies of the document that include at least one of the different variations of the text, so that individual copies of the document are traceable based on the different variation of the text included within that copy of the document; and determining, by the computing device, a recipient of a copy of the document based on a different variation of the text included with the copy.

Example 2 includes the subject matter of Example 1, wherein the generating of the different variations of text includes generating the different variations of text using natural language processing (NLP).

Example 3 includes the subject matter of Example 2, wherein the use of NLP includes sending a request to an NLP service, the request including at least a portion of the source document and an instruction for generating one or more variants of the source document.

Example 4 includes the subject matter of Example 3, wherein the instruction for generating one or more variants of the source document includes an instruction for removing and adding punctuation from the at least a portion of the source document.

Example 5 includes the subject matter of Examples 3 or 4, wherein the request further includes one or more examples of variants of the source document.

Example 6 includes the subject matter of Examples 1 to 5, and further includes: outputting, by the computing device, the copies of the document at one or more times; and storing information indicating the time at which individual copies of the document were output by the computing device, wherein the determining the recipient of a copy of the document includes determining a time at which the copy of the document was output by the computing device using the stored information.

Example 7 includes the subject matter of Examples 6, wherein the outputting of the copies of the document is in response to one or more requests for the source document.

Example 8 includes the subject matter of Examples 6 or 7, wherein the outputting of the copies of the document is in response to an input of a word processing application.

Example 9 includes the subject matter of Examples 1 to 8, and further includes: sending, by the computing device, the copies of the document to one or more other computing devices; and storing information for determining which individual copies of the document were provided to which of the one or more other computing devices, wherein the determining the recipient of a copy of the document includes determining which of the one or more other computing devices the copy of the document was provided to using the stored information.

Example 10 includes the subject matter of Examples 1 to 9, wherein the determining the recipient of a copy of the document includes determining the recipient based on an using of a hash of the copy of the document.

Example 11 includes the subject matter of Examples 1 to 10, wherein the determining the recipient of a copy of the document includes determining the recipient using an excerpt of the copy of the document.

Example 12 includes an apparatus including a processor and a non-volatile memory storing computer program code that when executed on the processor causes the processor to execute a process. The process includes: generating different variations of text based on a source document, the different variations to convey the same meaning as the source document while including content different than that of the source document; generating copies of the document that include at least one of the different variations of the text, so that individual copies of the document are traceable based on the different variation of the text included within that copy of the document; and determining a recipient of a copy of the document based on a different variation of the text included with the copy.

Example 13 includes the subject matter of Example 12, wherein the generating of the different variations of text includes sending a request to a natural language processing (NLP) service, the request including at least a portion of the source document and an instruction for generating one or more variants of the source document.

Example 14 includes the subject matter of Example 13, wherein the instruction for generating one or more variants of the source document includes an instruction for removing and adding punctuation from the at least a portion of the source document.

Example 15 includes the subject matter of Examples 13 or 14, wherein the request further includes one or more examples of variants of the source document.

Example 16 includes the subject matter of Examples 12 to 15, wherein the process further includes: outputting the copies of the document at one or more times; and storing information indicating the time at which individual copies of the document were output, wherein the determining the recipient of a copy of the document includes determining a time at which the copy of the document was output using the stored information.

Example 17 includes the subject matter of Examples 12 to 16, and further includes: sending the copies of the document to one or more computing devices; and storing information for determining which individual copies of the document were provided to which of the one or more computing devices, wherein the determining the recipient of a copy of the document includes determining which of the one or more computing devices the copy of the document was provided to using the stored information.

Example 18 includes the subject matter of Examples 12 to 17, wherein the determining the recipient of a copy of the document includes determining the recipient based on an using of a hash of the copy of the document.

Example 19 includes the subject matter of Examples 12 to 18, wherein the determining the recipient of a copy of the document includes determining the recipient using an excerpt of the copy of the document.

Example 20 includes a non-transitory machine-readable medium encoding instructions that when executed by one or more processors cause a process to be carried out. The process includes: generating, by a computing device, different variations of text based on a source document, the different variations to convey the same meaning as the source document while including content different than that of the source document; generating, by the computing device, copies of the document that include at least one of the different variations of the text, so that individual copies of the document are traceable based on the different variation of the text included within that copy of the document; and determining, by the computing device, a recipient of a copy of the document based on a different variation of the text included with the copy.

The subject matter described herein can be implemented in digital electronic circuitry, or in computer software, firmware, or hardware, including the structural means disclosed herein and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this disclosure, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and the memory can be supplemented by, or incorporated in, special purpose logic circuitry.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method comprising:
generating, by a computing device, different variations of text based on a source document, the different variations to convey the same meaning as the source document while including content different than that of the source document;
generating, by the computing device, copies of the document that include at least one of the different variations of the text, so that individual copies of the document are traceable based on the different variation of the text included within that copy of the document; and
determining, by the computing device, a recipient of a copy of the document based on a different variation of the text included with the copy.

2. The method of claim 1, wherein the generating of the different variations of text includes generating the different variations of text using natural language processing (NLP).

3. The method of claim 2, wherein the use of NLP includes sending a request to an NLP service, the request including at least a portion of the source document and an instruction for generating one or more variants of the source document.

4. The method of claim 3, wherein the instruction for generating one or more variants of the source document includes an instruction for removing and adding punctuation from the at least a portion of the source document.

5. The method of claim 3, wherein the request further includes one or more examples of variants of the source document.

6. The method of claim 1, further comprising:
outputting, by the computing device, the copies of the document at one or more times; and
storing information indicating the time at which individual copies of the document were output by the computing device,
wherein the determining the recipient of a copy of the document includes determining a time at which the copy of the document was output by the computing device using the stored information.

7. The method of claim 6, wherein the outputting of the copies of the document is in response to one or more requests for the source document.

8. The method of claim 6, wherein the outputting of the copies of the document is in response to an input of a word processing application.

9. The method of claim 1, further comprising:
sending, by the computing device, the copies of the document to one or more other computing devices; and
storing information for determining which individual copies of the document were provided to which of the one or more other computing devices,
wherein the determining the recipient of a copy of the document includes determining which of the one or more other computing devices the copy of the document was provided to using the stored information.

10. The method of claim 1, wherein the determining the recipient of a copy of the document includes determining the recipient based on an using of a hash of the copy of the document.

11. The method of claim 1, wherein the determining the recipient of a copy of the document includes determining the recipient using an excerpt of the copy of the document.

12. An apparatus comprising:
a processor; and
a non-volatile memory storing computer program code that when executed on the processor causes the processor to execute a process comprising:
generating different variations of text based on a source document, the different variations to convey the same meaning as the source document while including content different than that of the source document;
generating copies of the document that include at least one of the different variations of the text, so that individual copies of the document are traceable based on the different variation of the text included within that copy of the document; and
determining a recipient of a copy of the document based on a different variation of the text included with the copy.

13. The apparatus of claim 12, wherein the generating of the different variations of text includes sending a request to a natural language processing (NLP) service, the request including at least a portion of the source document and an instruction for generating one or more variants of the source document.

14. The apparatus of claim 13, wherein the instruction for generating one or more variants of the source document includes an instruction for removing and adding punctuation from the at least a portion of the source document.

15. The apparatus of claim 13, wherein the request further includes one or more examples of variants of the source document.

16. The apparatus of claim 12, wherein the process further includes:
outputting the copies of the document at one or more times; and
storing information indicating the time at which individual copies of the document were output,
wherein the determining the recipient of a copy of the document includes determining a time at which the copy of the document was output using the stored information.

17. The apparatus of claim 12, wherein the process further includes:
sending the copies of the document to one or more computing devices; and
storing information for determining which individual copies of the document were provided to which of the one or more computing devices,
wherein the determining the recipient of a copy of the document includes determining which of the one or more computing devices the copy of the document was provided to using the stored information.

18. The apparatus of claim 12, wherein the determining the recipient of a copy of the document includes determining the recipient based on an using of a hash of the copy of the document.

19. The apparatus of claim 12, wherein the determining the recipient of a copy of the document includes determining the recipient using an excerpt of the copy of the document.

20. A non-transitory machine-readable medium encoding instructions that when executed by one or more processors cause a process to be carried out, the process comprising:
generating, by a computing device, different variations of text based on a source document, the different variations to convey the same meaning as the source document while including content different than that of the source document;
generating, by the computing device, copies of the document that include at least one of the different variations of the text, so that individual copies of the document are traceable based on the different variation of the text included within that copy of the document; and
determining, by the computing device, a recipient of a copy of the document based on a different variation of the text included with the copy.
